(19) United States
(12) Patent Application Publication
(10) Pub. No.: US 2017/0072914 A1
(43) Pub. Date: Mar. 16, 2017

(54) ADAPTER FOR A CONDUIT FOR LIQUID AND DEVICE FOR THE DISTRIBUTION OF LIQUID IN A MOTOR VEHICLE

(71) Applicant: Valeo Systèmes d'Essuyage, Le Mesnil Saint Denis (FR)

(72) Inventor: Gérald Caillot, Cernay La Ville (FR)

(73) Assignee: Valeo Systèmes d'Essuyage, Le Mesnil Saint Denis (FR)

(21) Appl. No.: 15/264,651

(22) Filed: Sep. 14, 2016

(30) Foreign Application Priority Data
Sep. 16, 2015 (FR) 1558671

(51) Int. Cl. B60S 1/48; F16L 53/00

(52) U.S. Cl. CPC B60S 1/488; F16L 53/008

(57) ABSTRACT

Adapter (1) for a conduit for liquid for a distribution device (100) for liquid for a motor vehicle, the adapter (1) comprising:
at least one cannula (2) shaped so as to be inserted into a channel of one conduit (101) for liquid,
a housing (15) having at least one connection suitable for connecting a cannula (2, 2a, 2b) to a male tubular portion (31a, 31b, 32a, 32b) of a connecting element (3, 3a, 3b) for liquid,
   characterised in that the adapter for the conduit for liquid comprises heating means intended to heat at least part of the said adapter (1).

This invention relates to an adapter for a conduit for liquid for a device distributing wash liquid, in particular for windscreen wipers, in a motor vehicle, in which the wash liquid is heated/de-iced. This invention also relates to a distribution device fitted with such an adapter.

Motor vehicles are currently fitted with windscreen wiper systems which ensure that the driver has a clear view of his environment, in particular in the event of bad weather. Such a system generally comprises one or two windscreen wipers which scrape the outer surface of the windscreen to remove water and/or snow present on that surface out of the driver's field of view.

It is also known that vehicles are equipped with a wash system designed to spray wash liquid onto the windscreen, to help dissolve dirt, and thus increase the quality of cleaning of the windscreen, in particular through the action of the wiper system. In one version of the wash system this comprises nozzles located on the vehicle. In another version a windscreen wiper provided with its own wash liquid spraying component has been proposed. In other words, the wash liquid is sprayed from the windscreen wiper itself, from a spray nozzle or nozzles located along the said wiper.

The nozzles of the wash system, in particular the windscreen wipers, are fed with wash liquid contained in a tank through a pump. In order to do this a main conduit for liquid located beneath the bonnet of the vehicle carries wash liquid drawn from the tank by the pump to a distribution device comprising one or two non-return valves. This device in turn distributes the wash liquid into two secondary conduits for liquid, in particular towards the windscreen wipers. An intermediate component, known as an adapter, is currently used to connect the secondary conduits for liquid to the distribution device to aid connection/disconnection of the secondary conduits for liquid to and from the distribution device.

When temperatures are cold or even negative it is known that the wash conduits for liquid can be heated, each conduit comprising an extruded sleeve of channels and electrically heating conductors embedded in the mass. For example, when the temperature of the wash liquid is too low, for example below 5° C., the wash liquid is heated/de-iced. In order to do this the main and secondary transport conduits heat the wash liquid drawn from the tank by the pump to the no for example at the time when the windscreen wash command is operated, generally through the control lever located alongside the steering wheel and controlling activation of the windscreen wipers, among other things. Thus the windscreen wash liquid is heated and delivered in the conduit to the no without any obstacle in the channel for the wash liquid.

However it should be noted that, despite heating in the conduits, in some cases the wash liquid present in the adapter, that is the distribution device, may freeze. Freezing of the wash liquid in the adapter has adverse consequences, on the one hand blocking the spray function of the nozzles or windscreen wiper, and on the other hand contributing to rendering the adapter structure assembly rigid, even breaking some component elements of the adapter, but also the distribution device connected to the adapter.

One of the objects of this invention is to provide an adapter for a conduit for wash liquid and a wash liquid distribution device comprising heating means intended to heat the adapter and as a consequence the distribution device adjacent to the adapter.

With this object this invention relates to an adapter for a conduit for liquid for a liquid distribution device for a motor vehicle, the adapter comprising at least one cannula shaped so as to be inserted into a channel of a conduit for liquid, a housing having at least one connection capable of connecting the cannula to a male tubular portion of the connecting element for liquid,

the cannula opening into the housing in such a way as to allow fluid to pass between the cannula and the housing,
characterised in that the adapter for a conduit for liquid comprises heating means intended to heat at least part of the said adapter.

Thanks to this heating means located within the adapter for a conduit for liquid and the proximity of the liquid distribution device, the liquid present in the adapter and the distribution device will not freeze. In fact, providing heat continuously to a zone which is particularly sensitive to frost makes it possible to ensure optimum functioning of the wiper spray function and to do so at negative temperatures.

In the context of this invention, by wash liquid is meant any liquid of the screen wash type appropriate for cleaning a glazed surface of a vehicle, in particular cleaning associated with the use of windscreen wipers.

According to one or several characteristics of the adapter, taken alone or in combination:
the cannula and the housing of the adapter for a conduit for liquid are made of one piece, in particular of plastics material;
the cannula has an internal cross-section of tubular shape;
the cannula comprises holding means to hold the channel of the conduit for liquid inserted onto the said cannula;
   the holding means of the cannula is at least partly provided by at least one radial rib located on the outer periphery of the cannula,
the holding means of the cannula is at least partly provided by a cannula of frustoconical shape,
the cannula is at least partly formed of a narrowing annular end portion following an annular barb-shaped portion provided in the thickness of the cannula,
the means holding the cannula in the channel comprises an outer hoop element of one piece with the cannula, to guide and hold the cannula in the channel of the conduit for liquid,
the connection is configured to connect the housing to the male tubular portion of a liquid connecting element by being pushed on,
the housing is an open cavity,
the adapter for a conduit for liquid comprises a wall located between the cannula and the housing,
the cannula extends along a longitudinal axis perpendicular to the wall separating the cannula and the housing,
the wall delimits the base of the cavity of the housing,
the wall is of substantially oblong shape,
the adapter comprises at least one annular seal located at the base of the housing cavity, preferably in contact with the wall,
the annular seal is located between the male tubular portion of the connection element for liquid and the housing in the assembled position,
the cannula opens into the housing to allow wash liquid to pass between the cannula and the housing,
the adapter comprises passage means for the heating means,
the passage means is formed by at least one opening in the wall,
the heating means comprises at least one heating wire, and preferably two heating wires,
the heating wire passes through the cavity of the housing,
the heating wire is located close to the cannula,
the heating wire is connected to an electrical connector,
the adapter comprises two entry cumin shaped so as to be inserted into a respective channel of a conduit for liquid having two channels,
the heating wire is located between the said inlet cannulas,
the adapter has two holding means for holding the inlet cannulas in their respective channels,
the housing has two connections to connect the net cannulas to two male tubular portions respectively of two connecting elements for liquid.

The invention also relates to a device for the distribution of motor vehicle wash liquid, in particular for windscreen wipers, comprising at least one conduit for liquid having at least one channel, the distribution device comprises an adapter according to the invention to connect at least one male tubular portion of a connecting element for liquid to a conduit for liquid.

The device for the distribution of motor vehicle wash liquid/washing liquid distribution is for example constituted by a liquid line and an adapter according to the invention to connect at least one male tubular portion of a connecting element to the liquid line.

According to particular embodiments of the device
the at least one channel is an extruded sleeve,
the heating wire is at least partly located within the extruded sleeve,
the liquid distribution device comprises a liquid connecting element comprising two male tubular portions having substantially parallel axes, each male tubular portion having a barb-shaped radial rib located on the outer periphery, the said barb-shaped radial ribs being axially offset from one another.

Other advantages and features of the invention will be apparent from the description of embodiments below provided with reference to the appended drawings in which:

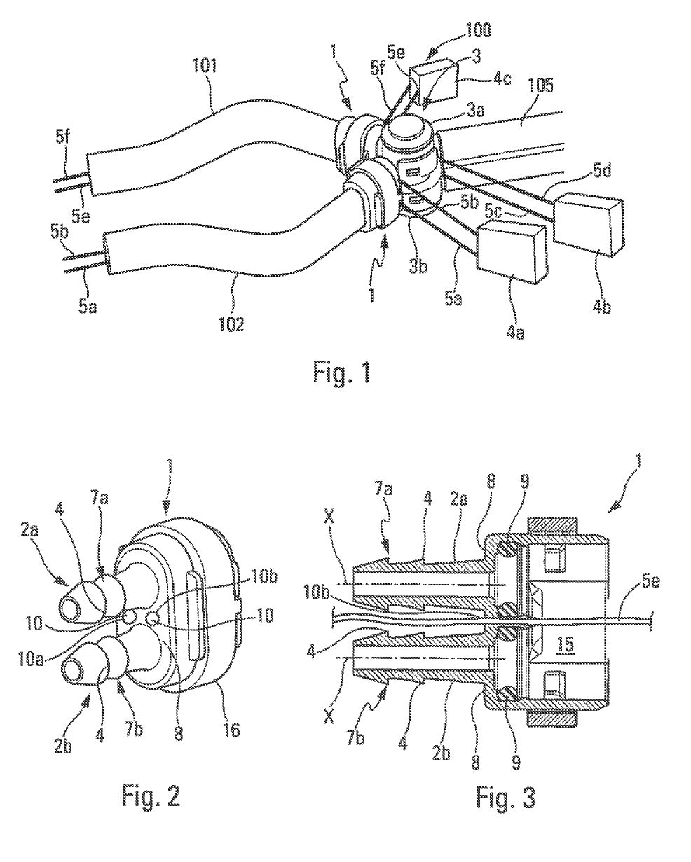

FIG. 1 shows a diagrammatical view of the elements of a motor vehicle wash liquid distribution device,

FIG. 2 shows a diagrammatical view of an adapter for a conduit for liquid for a motor vehicle wash liquid distribution device,

FIG. 3 shows a view of the adapter in FIG. 2 in longitudinal cross-section,

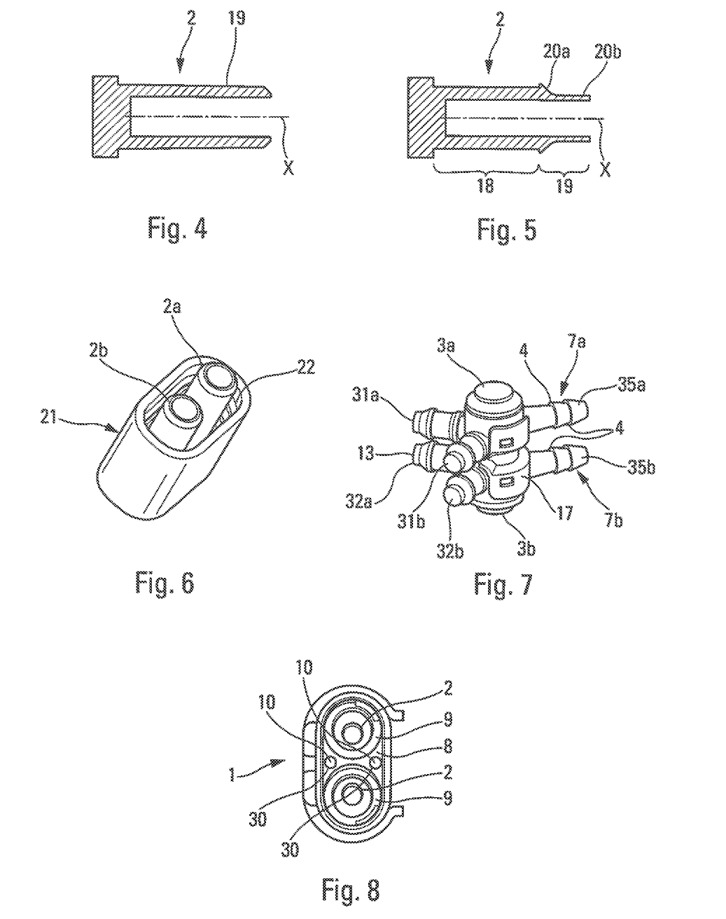

FIG. 4 shows a partial diagrammatical view of a cannula of an adapter according to a variant embodiment in partial cross-section,

FIG. 5 shows a partial diagrammatical view of a cannula of an adapter according to another variant embodiment in partial cross-section,

FIG. 6 shows a perspective view of an adapter according to a first variant embodiment seen from the side intended to be connected to a conduit for liquid,

FIG. 7 shows a diagrammatical view of two connecting elements assembled to each other, and

FIG. 8 shows a lateral view of the adapter in FIG. 2 intended to be connected to two connecting elements.

In these figures identical elements have the same reference numbers.

FIG. 1 shows a wash liquid distribution device 100 comprising a principal conduit 105 for liquid located beneath the bonnet of a motor vehicle, two secondary conduits 101, 102 for liquid, two connecting elements 3 for liquid which are, as illustrated, non-return valves 3a, 3b, or, in a variant not illustrated, simple Y-connectors without an incorporated non-return valve, two adapters 1 for conduit for liquid and two electrical connectors 4a, 4b intended to provide an electricity supply to heating wires 6a, 5b, 5c, 5d, 5e, 6f connected to said electrical connectors 4a, 4b and 4c.

Main conduit 105 for liquid beneath the bonnet is hydraulically connected to both a tank and non-return valves 3a, 3b. The two secondary conduits 101, 102 for liquid are hydraulically connected to both non-return valves 3a, 3b and to the nozzles for spraying wash liquid. The nozzles (not shown) are for example located on respective spray manifolds on the driver and passenger windscreen wipers, or on a support attached to the structure of the vehicle close to the surface requiring cleaning.

Non-return valves 3a, 3b allow pumped liquid to pass in the direction of flow from the pump to the nozzles and block return flow of pumped liquid in the other direction, that is to say from the nozzles towards the pump. Non-return valves 3a, 3b thus prevent any back-up of wash liquid towards the pump, in particular during the stage in which distribution of liquid in the channels is stopped.

In particular non-return valves 3a, 3b allow pumped liquid to pass in the direction of flow from the pump towards the wiper spray manifold and block the return flow of pumped liquid from the wiper spray manifold towards the pump. Non-return valves 3a, 3b thus prevent any back-up of liquid from the windscreen wipers to the pump.

Main conduit 105 comprises an extruded sleeve having two superimposed channels and comprises two heating wires 5c, 5d embedded in the mass of the sleeve. Main conduit 105 is of flexible material, for example rubber. The conduits for windscreen wiper liquid in which heating wires 5c, 5d are located are in particular obtained by extrusion; heating wires 5c, 5d are for example introduced with the material during the extrusion operation. In a variant the conduits are extruded with two holes made to receive the heating wires subsequently.

Windscreen wiper secondary conduits 101, 102 are similar to main conduit 105 beneath the bonnet. They each have an extruded sleeve with two superimposed channels and two heating wires embedded in the mass of a sleeve. Each heating wire is connected to an electrical connector 4a, 4b, 4c.

Thus, as may be seen in FIG. 1, connector 4b supplies electricity to heating wires 5c and 5d to heat main conduit 105 for liquid. Electrical connector 4a supplies electricity to heating wires 5a and 5b to heat secondary conduit 102 for liquid. In the same way another electrical connector (not shown) supplies electricity to heating wires 5e and 5f to heat secondary conduit 101 for liquid.

Being on the side of the two secondary conduits 101 and 102 for liquid, heating wires 5a, 5b, 5e, 5f also pass through each adapter 1 for the conduit for liquid through the intermediary of passages in the form of holes located in these adapters.

Thus heating wires 5a, 5b, 5e, 5f heat conduits 101, 102 over their entire length, and also heat adapters 1, which prevents adapters 1 from freezing.

FIG. 2 shows an adapter 1 for connecting male tubular portions of non-return valves 3a, 3b respectively to a secondary conduit 101, 102 for liquid respectively. The two adapters 1 are identical.

Each adapter 1 comprises:
two net cannulas 2a, 2b shaped so as to be inserted into a respective channel of the secondary conduit for liquid,
two holding means 7a, 7b to hold each net cannula 2a, 2b in its respective channel and
two passage means 10a, 10b in the form of holes 10 intended for the passage of heating wires 5a, 5b and 5e, 5f respectively to heat the adapter,
a clasp 16 having the general shape of a clip enclosing the outer was of the adapter, acting as means for locking the adapter onto the liquid distribution device.

As may be seen in FIG. 2, passage means 10a and 10b are in the form of holes 10 located in wall 8 of adapter 1, more specifically between the two net cannulas 2a and 2b, in order to be located as close as possible to the zones through which the wash liquid passes. These passage means 10a and 10b allow heating wires 5e, 5f emerging from the end of secondary conduit for liquid opposite adapter 1 to pass through.

More visibly in cross-section in FIG. 3, on the side on which the secondary conduit for liquid is connected, holding means 7a, 7b for net cannulas 2a, 2b comprises two radial ribs 4 of generally frustoconical shape. The radial ribs are arranged around the outer periphery of each cannula 2a, 2b so as to had cannulas 2a, 2b in the respective channels of the secondary conduit for liquid through deformation, and to ensure a seal.

Inlet cannulas 2a, 2b have an internal cross-section of tubular shape. The X axes of net cannulas 2a, 2b are substantially parallel to each other with a spacing corresponding to the spacing of the channels in the secondary conduits for liquid. Inlet cannulas 2a, 2b are located one above the other, in a superimposed arrangement.

Adapter 1 also has a housing 15 having two connections for connecting two male tubular portions of two non-return valves 3a, 3b respectively. This housing 15 is a cavity which opens in the direction of the two male tubular portions 11, 13 of the two non-return valves 3a, 3b.

The two inlet cannulas 2a, 2b and housing 15 are made of a single piece of plastics material. For this purpose there is a wall 8 between inlet cannulas 2a, 2b and housing 15. This wall 8 acts as a link between inlet cannulas 2a, 2b and housing 15. Once secondary conduits 101, 102 for liquid are in position on inlet cannulas 2a, 2b, heating wires 5a, 5b and 5e, 5f emerging from secondary conduits 101, 102 for liquid pass through wall 8 of the corresponding adapter through passage means 10a, 10b to heat housing 15. In the example illustrated wall 8 is located perpendicularly to the X axis of inlet cannulas 2a, 2b.

Passage means 10a, 10b for the heating wires are made in the form of through holes located between the two inlet cannulas 2a, 2b of adapter 1. The heating wires then pass through housing 15 to collect the electrical connector associated with the heating wires.

Adapter 1 comprises two annular seals 9, each located in a groove provided in housing 15. Annular seals 9 are intended to act together with a frustoconical annular rib of male tubular portion 31a, 31b, 32a, 32b of non return valves 3a, 3b by being pushed on. Alternatively the annular seals are supported by a male tubular portion of non-return valves 3a, 3b.

The two annular seals 9 are in direct contact with wall 8 in the assembled position.

According to a second embodiment of the holding means illustrated in FIG. 4, the internal cross-section of cannulas 2a, 2b has a tubular shape of constant diameter whereas part 19 has an outer cross-section of frustoconical shape. The narrowest section of the frustoconical shape is located at the free end, which makes it easier to push the secondary conduit for liquid onto cannulas 2.

According to a third variant embodiment illustrated in FIG. 5, the holding means of the cannula comprises a narrowing terminal annular portion 20b following en annular barb-shaped portion 20a provided in the thickness of the cannula to hold the cannula in the channel of secondary conduit 101, 102 for liquid by engaging with it. Cannula 2 has a part 18 of external cross-section of tubular shape of constant diameter.

According to a fourth variant embodiment illustrated in FIG. 6, the holding means of the inlet cannulas further comprises an external hoop element 21 of one piece with inlet cannulas 2a, 2b to guide assembly and to hold the cannula within the channel of secondary conduit 102 for liquid. The exterior hoop element may also have peripheral internal holding projections 22, in particular annular projections as illustrated.

FIG. 7 shows non-return valves 3a and 3b each having a tubular net portion 35a and 35b and two tubular male outlet portions 31a, 32a, and 31b and 32b respectively, for example in a Y arrangement. The non-return valves have a generally cylindrical shape and are made for example of plastics material. The non-return valves are located one above the other, for example housed in a support 17, for example in such a way that the male tubular portions are substantially parallel to each other.

1. An adapter for a conduit for liquid for a distribution device for motor vehicle wash liquid, the adapter comprising:
at least one cannula configured to be inserted into a channel of a conduit for liquid; and
a housing having at least one connection suitable for connecting the cannula to a male tubular portion of a connecting element for liquid,
wherein the adapter for the conduit for liquid comprises at least one heating means intended to heat at least part of the said adapter.

2. The adapter for a conduit for liquid according to claim 1, wherein the cannula and the housing are made of one piece, of plastics material.

3. The adapter for a conduit for liquid according to claim 2, wherein the cannula has an internal cross-section of tubular shape.

4. The adapter for a conduit for liquid according to claim 3, wherein the cannula has holding means to hold the channel of the conduit for liquid inserted onto the said cannula,
the said holding means of the cannula comprises at least partly at least one of a radial rib located on the outer periphery of the cannula,
a part of frustoconical shape,
a narrowing annular end portion following an annular barb-shaped portion provided in the thickness of the cannula,
an outer hoop element of one piece with the cannula intended to guide and hold the cannula in the channel of the conduit for liquid.

5. The adapter for a conduit for liquid according to claim 1, wherein the connection is configured to connect the housing to the male tubular portion of a connecting element for liquid by being pushed on.

6. The adapter for a conduit for liquid according to claim 5, wherein the housing is an open cavity.

7. The adapter for a conduit for liquid according to claim 1, further comprising a wall located between the cannula and the housing, bounding the base of the housing, the wall being of substantially oblong shape.

8. The adapter for a conduit for liquid according to claim 8, wherein the adapter has at least one annular seal located at the base of the housing cavity in contact with the wall.

9. The adapter for a conduit for liquid according to claim 8, wherein the annular seal is placed between the male tubular portion of the connecting element for liquid and the housing in the assembled position.

10. The adapter for a conduit fair liquid according to claim 1, wherein the adapter has passage means for the heating means, formed by at least one opening in the wall.

11. The adapter for a conduit for liquid according to claim 1, wherein the heating means comprises at least one heating wire and two heating wires.

12. The adapter for a conduit for liquid according to claim 11, wherein the heating wire passes through the cavity of the housing.

13. The adapter for a conduit for liquid according to claim 11, wherein the adapter comprises two cannulas shaped so as to be inserted into a respective channel of a conduit for liquid having two channels.

14. The adapter for a conduit for liquid according to claim 13, wherein the heating wire is located between the said cannulas.

15. A device for the distribution of liquid for a motor vehicle comprising:
at least one conduit for liquid having at least one channel; and
an adapter according to claim 1 to connect at least one male tubular portion of a connecting element for liquid to a conduit for liquid.

16. The distribution device for liquid according to claim 15, wherein the channel is an extruded sleeve.

17. The distribution device for liquid according to claim 16, wherein the heating wire is located within the extruded sleeve.

18. The distribution device for liquid according to claim 17, further comprising:
a connecting element for liquid comprising two male tubular portions having substantially parallel axes, each male tubular portion having a barb-shaped radial rib provided on the exterior periphery, the said hook-shaped radial ribs being axially offset from one another.
